(19) United States
(12) Patent Application Publication
(10) Pub. No.: US 2008/0141369 A1
(43) Pub. Date: Jun. 12, 2008

(54) Method, Device and Program for Detecting Address Spoofing in a Wireless Network

(75) Inventors: Laurent Butti, Issy Les Moulineaux (FR); Roland Duffau, Paris (FR); Franck Veysset, Issy Les Moulineaux (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/883,140

(22) PCT Filed: Jan. 24, 2006
(86) PCT No.: PCT/FR06/00162

§ 371 Date: Sep. 24, 2007

(30) Foreign Application Priority Data
Jan. 26, 2005 (FR) 05/00798

(51) Int. Cl. G06F 11/00

(52) U.S. Cl. 726/22

(57) ABSTRACT

A method is provided whereby management frames, transmitted over the wireless network and comprising each an address of a frame transmitter and a frame body containing a plurality of information fields are obtained. Some of the information fields contained in the frame body of several management frames obtained successively and having the same transmitter address are analyzed so as to trigger an alarm in case of detected variation in said information fields.

The present invention relates to technologies for wireless access to telecommunication networks. It applies in particular to technologies of IEEE 802.11 type standardized by the Institute of Electrical and Electronics Engineers (IEEE). IEEE 802.11 technologies are much used in company networks, home networks and areas of intensive use (“hot spots”). More particularly, the invention pertains to wireless network piracy by access point address spoofing.

Here, the term “frame” designates a set of data forming a block transmitted in a network and incorporating useful data and service information, generally located in a header area of the block. Depending on the context, frame can connote data packet, datagram, data block, or other expressions of this type.

With the success and democratization of wireless access technologies, piracy or attack techniques have appeared.

Currently, one of the most significant risks for networks of this type is attack by illegitimate access point, which consists in creating a false access point by completely spoofing the characteristics, in particular the MAC (“Medium Access Control”) layer address of a legitimate access point, controlled by the wireless network administrator. False access points that do not spoof a MAC address of a legitimate access point are relatively easy to detect by simple MAC address verification.

The access point is a paramount element of the communication between a client and a network. Hence, it is a critical point, and therefore of interest to attackers. Attacks using false access points have appeared with the objectives of:
collecting connection identifiers for users that are authenticated by means of “captive portals” by passing themselves off as a legitimate access point so as to intercept identification data such as the connection identifiers;
intercepting communications by carrying out a “man in the middle” type attack, that is to say by simulating the behavior of a legitimate access point in relation to the wireless user and that of a wireless user in relation to the legitimate access point so as to intercept all the communications; and
opening up an entire company network by leaving an access point directly connected to the network of the company in open mode, that is to say without any authentication or encipherment of the radio channel, this access point accepting by default any connection request.

These attacks are hard to detect when they implement a MAC address spoofing technique. It is then more difficult to distinguish two different items of equipment of the same category sending from the same MAC address. The arrival of the new securer standards (IEEE 802.11i) will not prevent the use of illegitimate access points since they will still be attractive to the attacker.

There therefore exists a requirement for a method of detecting access point MAC address spoofing.

A known technique for detecting MAC address spoofing relies on the analysis of the sequence number field of the IEEE 802.11 frames. These sequence numbers, managed at low level in the radio card, are compulsorily incremented by one unit with each packet sent. This makes it possible to log significant variations between several successive packets sent by one and the same MAC address. By comparing these variations with predefined thresholds, it is possible to detect anomalies in the packets appearing that originate from a MAC address, and deduce therefrom the probable spoofing of this address by an attacker.

This technique requires the management of very precise thresholds that are difficult to set. It is difficult to implement it on its own and to be sure there are no false positives (false alarms) and false negatives (undetected attacks). The main difficulty is how to manage packet losses, for example during a long-distance transmission. Specifically, some packets are then lost, thus causing problems of false positives since the sequence numbers vary greatly from one packet to another. It is necessary to manage the detection thresholds in a very subtle manner. This is why this technique is often insufficient and must be combined with one or more others so as to correlate the alarms and thus have more confidence in the alarms raised.

An aim of the present invention is to tackle this problem area and more generally to propose a new procedure for detecting address spoofing in a wireless network of IEEE 802.11 or analogous type.

The invention thus provides a method of detecting address spoofing in a wireless network, comprising:
obtaining management frames transmitted over the wireless network, each management frame comprising an address of a sender of the frame and a frame body containing several information fields;
analysing at least some of the information fields contained in the frame bodies of several successively obtained management frames exhibiting one and the same sender address; and
triggering an alarm in the event that a variation is detected in at least some of the analysed information fields.

The body of IEEE 802.11 management frames contains information on the technical characteristics of the networks and clients. Typically, an access point informs anyone in its vicinity of the network to which it belongs by broadcasting in particular a network name and lower-level information such as the support of the various radio bit rates of the IEEE 802.11 cards (11 Mbps, 22 Mbps, 54 Mbps, etc). This information is provided by the controller (driver) and cannot be modified easily by the user without significant modifications thereof. It is therefore beneficial to analyse these parameters closely. If a difference is detected, it is possible to affirm that two different items of equipment are communicating with the same MAC address. Specifically, some of these parameters are individual to the card and to its driver and cannot be easily modified on the fly by an attacker.

The invention applies in particular to the so-called Beacon and Probe Response frames, which are sent by the access points. But it can also apply to other types of frames such as the Probe Requests which are sent by the clients, even if the information contained in the observed fields is then not as rich. The invention is akin to a signature creation method for the cards/drivers supplying the analysed fields.

In embodiments of the method:
the number of information fields of the frame body of each management frame obtained is determined, and an alarm is triggered if the number of information fields determined is observed to vary between two successively obtained management frames;
the information fields of the frame body are separated into a first category containing information that is invariant for a sender and a second category containing information that can vary for a sender, and an alarm is triggered in the event that a variation is detected in the information contained in at least one of the information fields of the first category;
a numerical string is constructed on the basis of at least some of the analysed information fields for an obtained management frame, a signature is calculated by hashing said numerical string, and an alarm is triggered in the event that there is a variation between the signatures calculated for two successively obtained management frames;
a statistic regarding the information contained in at least some of the information fields of the frame body of management frames received from a sender is determined, and an alarm is triggered in the event of observing at least one management frame containing the address of said sender and a frame body having information fields that are inconsistent in relation to the statistic determined.

Another aspect of the invention pertains to a computer program to be installed in a device interfaced with a wireless network for execution by a processing unit of this device. The program comprises instructions for implementing a method as defined above during execution of the program by said processing unit.

Yet another aspect of the invention pertains to a device for detecting address spoofing in a wireless network, comprising:
obtention means for obtaining management frames transmitted over the wireless network, each management frame comprising an address of a sender of the frame and a frame body containing several information fields;
analysis means for analysing at least some of the information fields contained in several successively obtained management frames exhibiting one and the same sender address; and
triggering means for triggering an alarm in the event that a variation is detected in at least some of the analysed information fields.

Other features and advantages of the present invention will appear in the description hereafter of nonlimiting exemplary embodiments, with reference to the appended drawings, in which:

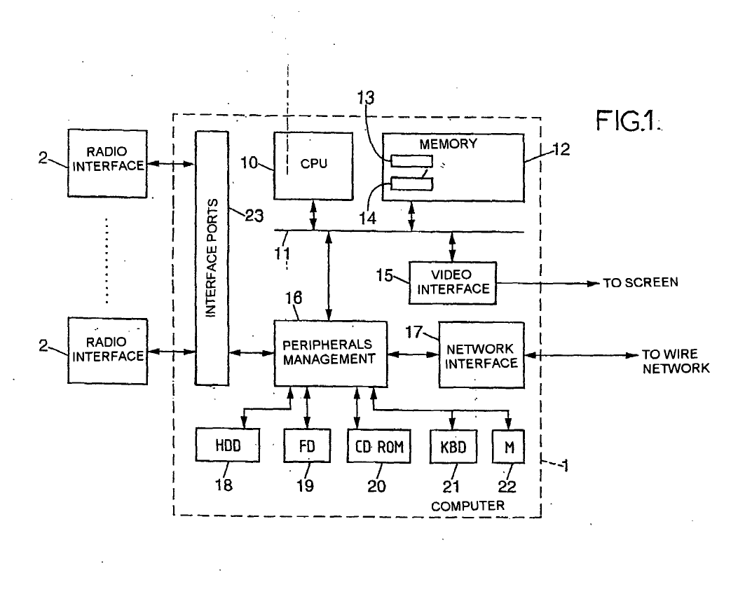

FIG. 1 is a schematic diagram of a device for detecting address spoofing according to the invention;

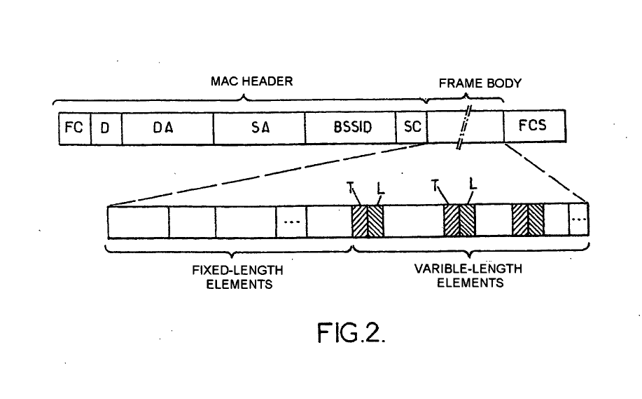

FIG. 2 is a chart illustrating the content of an IEEE 802.11 management frame; and

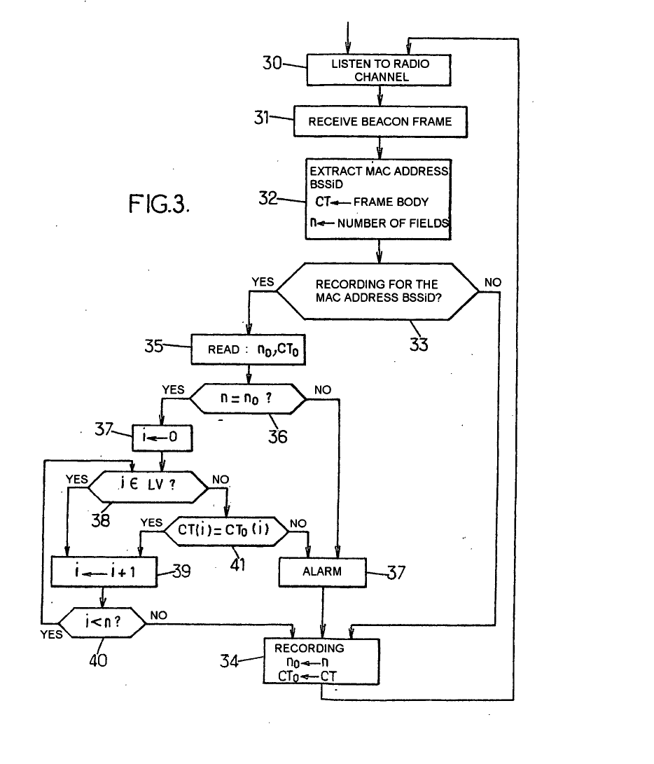

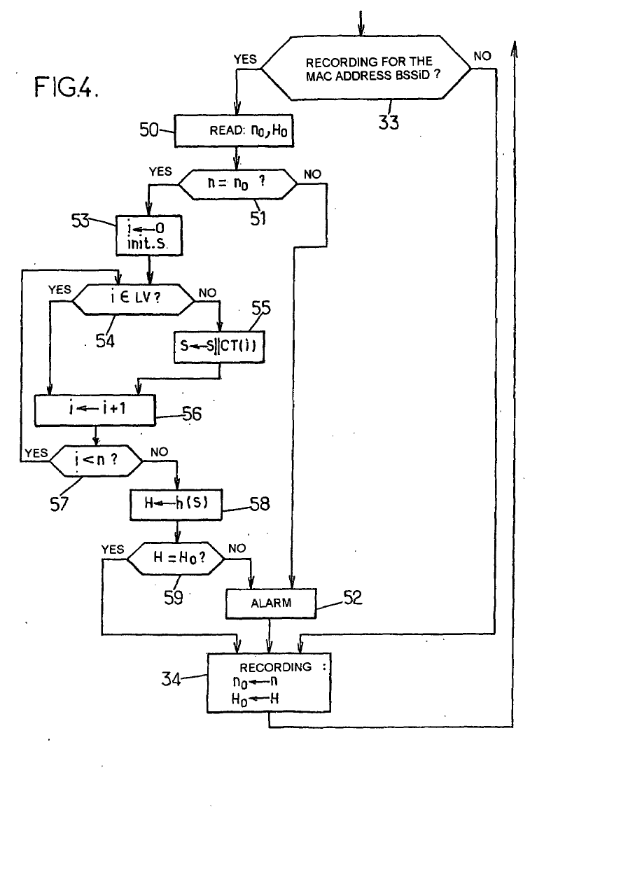

FIGS. 3 and 4 are flowcharts of examples of methods according to the invention.

The invention is described hereafter in its particular application to the detection of MAC address spoofing in a wireless network of IEEE 802.11 type

The well known method for associating an IEEE 802.11 client with an access point is as follows. In an access point discovery phase, the client apparatus listens to the radio channel so as to search for specific frames called beacons. The client examines the information contained in this type of frame, in particular the network name (SSID, “Service Set Identifier”) and the parameters individual to the network deployed. Thereafter, the client sends out access point search frames (“Probe Requests”) containing the network name (SSID) sought. The access point (points) concerned responds (respond) to the request by returning a “Probe Response” frame signaling their presence. On the basis of the elements thus discovered, the client selects the desired access point and asks to authenticate himself therewith. If the authentication succeeds, the client asks to associate himself with the access point. If the association succeeds, the client is capable of dispatching and receiving data via the access point to which he is connected.

When using an illegitimate access point on the radio channel, the attacker generally uses a technique of complete spoofing of the access point: same network name (SSID), same MAC address. But he generally does not use the same radio channel for radio interference reasons.

The detection of illegitimate access points according to the invention can be done with the aid of a computer furnished with a radio interface conforming to one of the physical layers of the IEEE 802.11 standard using a radio link. Radio physical layers are in particular defined by the standards IEEE 802.11a, IEEE 802.11b or IEEE 802.11g. FIG. 1 shows an example of a detection device comprising a computer 1 linked to several radio interfaces 2.

The computer 1 is for example a standard computer which comprises a central processing unit 10 linked to a bus 11. A memory 12 which can comprise several memory circuits is linked to the bus 11 so as to cooperate with the central processing unit 10, the memory 12 serving at one and the same time as data memory and program memory. Areas 13 and 14 are envisaged for the storage of 802.11 management frames such as Beacon frames, Probe Request frames or Probe Response frames. A video interface 15 can be linked to the bus 11 so as optionally to display messages on a screen for an operator.

A circuit for managing the peripherals 16 is linked to the bus 11 so as to link up with various peripherals according to a known technique. Of the various peripherals which can be linked to the peripheral management circuit, only the main ones are represented: a network interface 17 which makes it possible to communicate with a wire-based network, a hard disk 18 for the programs and data, a diskette reader 19, a CDROM reader 20, a keyboard 21, a mouse 22 and interface ports 23. The ports 23 conform for example to the PCMCIA or USB standard. One of the programs that are recorded on the hard disk and that can be loaded into the work memory of the central processing unit 10 for execution serves for the detection of the illegitimate access points (or clients) when the device is made to listen in on the radio channel. Such a program can be written in any appropriate language on the basis of the flowcharts described further on.

One or several radio interfaces 2 are connected to the interface ports 23. Radio interfaces compatible with the IEEE 802.11 standard have radio means making it possible to listen simultaneously to only a reduced number of radio channels. If required, in particular if the user wishes to listen to the whole of the communication band, it may be desirable to associate several interfaces 2 with the device 1.

FIG. 2 shows the conventional structure of an IEEE 802.11 management frame. The management frames include in particular the Beacon frames, Probe Request frames and the Probe Response frames. Each comprises a MAC layer header, a frame body and a frame verification sequence FCS, of four bytes, enabling the receiver to verify the integrity of the received frame.

The MAC header begins with two control bytes FC providing various indications. The control bytes include in particular two type bits whose 00 value denotes a management frame, and four sub-type bits whose 1000 value denotes a Beacon frame, whose 0100 value denotes a Probe Request frame, whose 0101 value denotes a Probe Response frame, etc. Another field, of six bytes, of the MAC header contains the MAC address, called the BSSID (“Basic Service Set Identifier”), of the frame sender's access point. In the case of a management frame sent by a client, such as a Probe Request, the six-byte source address field (SA) contains the MAC address of this client.

The frame body of an IEEE 802.11 management frame includes two types of information elements: fixed-length elements placed at the start of the frame body and variable-length elements which follow. The fixed-length elements can in particular comprise:
a frame timestamp coded on eight bytes;
a beacon interval coded on two bytes and indicating the time interval between two transmissions of Beacon frames by the access point;
capability information coded on two bytes and indicating whether or not the network supports various functions provided for in the standard; etc.

The fixed-length elements present in a management frame are determined by the frame sub-type indicated in the MAC header, so that they can be decoded by the receiver. For example, the Beacon and Probe Response frames comprise the “timestamp”, “beacon interval” and “capability information” fields in that order, while the Probe Request frames do not contain any fixed-length elements in their frame body.

Each variable-length element of the frame body begins with a label byte T which denotes the type of element and with a length byte L which denotes the number of bytes on which the value of the element is coded. The presence of a variable-length element in a management frame is detected by the receiver by examining whether there is a label byte T after the previously decoded element. The variable-length elements, often optional, can in particular comprise:
a network name corresponding to the SSID;
a “supported rates” field which indicates the transmission bit rates supported by the sender;
a “DS parameter set” field which indicates the parameter sets usable by the sender if the direct sequence-type radio layer is supported;
an “FH parameter set” field which indicates the parameter sets usable by the sender if the frequency hop radio layer is supported;
a “traffic indication map” field which denotes clients having information waiting to be sent, so as to warn them if it is in standby mode; etc.

Some of the information elements of the frame body have, by their very nature, variable values. This is the case for the “timestamp” or “traffic indication map” fields. A detection device according to the invention stores a list LV where these variable information elements are itemized. The itemization can be performed by the operator of the detection device by virtue of the knowledge of the infrastructure deployed.

The other information elements are generally fixed, and it may be very difficult to modify them, especially in the frequent case where the corresponding values result from the hardware construction of the radio card. The invention utilizes this property to aid the detection of the possible spoofing of the MAC address of an access point or a station.

FIG. 3 illustrates an exemplary flowchart of a program implementing the detection of access point spoofing according to the invention. The method is based here on the observation of Beacon frames picked up on the radio channel.

The program causes the device to listen passively to the radio channel (step 30). On receipt 31 of a frame detected as being of the Beacon sub-type on account of the MAC header control bytes, step 32 of extracting the MAC address BSSID and the CT fields of the body of the frame received is carried out. The number n of fields (of fixed or variable length) of the frame body is also determined. If the memory of the device does not contain any valid recording relating to a Beacon frame received with the extracted MAC address BSSID (step 33), a valid recording is placed in memory for the current frame in step 34. In the example considered here, the data recorded in conjunction with the MAC address BSSID are the number of fields n and the fields CT of the frame body which were obtained in step 32. The recorded values are denoted n₀ and CT₀. Preferably, the management of the memory can be such that the recording 34 is kept valid only for a duration t defined by the operator. This duration t is for example of the order of some ten seconds at most.

If step 33 reveals that the memory of the device contains a valid recording for the MAC address BSSID, the recorded values n₀, CT₀ are read in step 35. A first test 36 is then performed by comparing the number n of fields of the body of the current frame with that n₀ of the preceding frame. In the absence of spoofing, these two numbers should in principle be equal. If they are not, the method considers that MAC address spoofing is probable, and it triggers an alarm 37.

If n=n₀ in test 36, the information elements CT(0), CT(1), . . . , CT(n−1) of the frame body are examined successively in a loop 37-41. The loop index i is initialized to 0 in step 37. Step 38 examines whether the field of rank i is in the list LV of fields whose variations are accepted. If it is, we simply go to the next field by incrementing the index i in step 39 and then comparing it with n in step 40. So long as i<n, the loop returns to step 38. If the field of rank i is by nature invariant, the second test 41 compares its content CT(i) with that CT₀(i) corresponding to it in the recording made for the preceding frame. In the event of equality, the loop index I is incremented 39. In the event of a difference in the value of the field or, in the case of a variable-length field, in its label byte or length byte, the method triggers an alarm 37.

The field verification loop terminates either on an alarm or when i reaches the value n in step 40. The process then terminates by recording 34 the elements relating to the current frame before returning to the listening step 30.

The alarm 37 signaled to the operator of the device (typically the wireless network administrator) can be accompanied by data indicating the cause of the alarm, namely which field has shown an abnormal variation or the fact that the number of fields n has varied.

FIG. 4 illustrates, starting from step 33 previously described, an optimized variant of the method in which a bitwise verification of the information fields of the analysed frames is not performed. A cryptographic function h of hash function type, for example SHA1 or MD5 which are well known in cryptography, is used to generate a signature on p bits (p=160 for SHA1; p=128 for MD5) for each analysed frame. The comparison made to detect a possible address spoofing pertains to this signature.

The signature generated for the current frame is denoted H. It is recorded with the number of fields n in step 34. When step 33 reveals a valid recording for the MAC address BSSID, the recorded values n₀, H₀ are read in step 50. A first test 51 is then performed by comparing the number n of fields of the body of the current frame with that n₀ of the preceding frame. If these two numbers are not equal, the method considers that MAC address spoofing is probable, and it triggers an alarm 52.

If n=n₀ in test 51, the numerical string S which will be subjected to the hash function h is assembled in a loop 53-57. The loop index i is initialized to 0 in step 53, and the string S is initialized, for example to an empty string. If the field of rank i is in the list LV (step 54), the method simply goes to the next field by incrementing the index i in step 56, and then comparing it with n in step 57. Otherwise, the content of the field i is concatenated to the end of the string S in step 55 before going to step 56. So long as i<n, the loop returns to step 54. When i reaches the value n in step 57, the hash function is applied to the string S in step 58 to generate the signature H of the current frame.

The next test 59 compares this signature H with that H₀ of the preceding frame. In the event of identity of the signatures, no alarm is triggered and the data n, H is recorded in step 34. If H≠H₀, the method triggers an alarm 52.

The method illustrated by FIG. 3 or 4 is readily extended to the monitoring of Probe Response frames. As these frames are sent only when requested by clients, it is appropriate to adapt their memory storage so as to preserve the information for a greater duration t. This duration can be adapted on the basis of the activity observed on the network to be protected.

It will be noted that it is not necessary to make the assumption that listening to the radio channel does not involve any frame losses, because the comparison is performed between two successive frames originating from one and the same MAC address (BSSID). Nothing is presupposed regarding the possible losses of equivalent frames between the receipt of the two analysed frames. Two frames are enough to compare them with one another, whatever frames are lost between these two frames.

When an alarm 37, 52 is triggered, the operator can take any appropriate measure to halt the spoofer's attack. In certain cases, an alarm may be triggered by the device following a network reconfiguration operation by its administrator, giving rise to certain changes of parameters. The administrator will then know that the alarm probably does not attest to a MAC address spoofing.

The method can also be applied by carrying out a statistical study of the content of several frames of one and the same type (Beacon, Probe Response) containing one and the same MAC address. It is possible to determine an average of the fields of the frame body, and to raise an alarm when the content of a current frame deviates from this average beyond a certain threshold. This implementation avoids the need to manage the distinction between the normally variable fields and the invariant fields of the frame body. The detection threshold can likewise depend on the statistic observed over several frames, in particular on the standard deviation. Generally, the determination of a statistic regarding the information contained in the information fields of the frame body or in some of them, makes it possible to trigger an alarm as soon as a frame with information fields that are inconsistent in relation to the statistic determined is observed.

The detection methods described above are transposable to management frames other than those sent by the access points. The invention is in particular applicable to frames sent by clients such as Probe Requests, although this is less effective because these frames usually comprise a smaller number of invariant fields.

1. A method of detecting address spoofing in a wireless network, comprising:
obtaining management frames transmitted over the wireless network, each management frame comprising an address of a sender of the frame and a frame body containing several information fields;
analysing at least some of the information fields contained in the frame bodies of several successively obtained management frames exhibiting one and the same sender address; and
triggering an alarm in the event that a variation is detected in at least some of the analysed information fields.

2. The method according to claim 1, in which the analysed information fields are extracted from management frames of at least one determined type.

3. The method according to claim 2, in which the wireless network is of IEEE 802.11 type and said determined types of the management frames are from among the Beacon, Probe Response and Probe Request types.

4. The method according to claim 1, in which the number of information fields of the frame body of each management frame obtained is determined, and in which an alarm is triggered if the number of information fields determined is observed to vary between two successively obtained management frames.

5. The method according to claim 1, in which the information fields of the frame body are separated into a first category containing information that is invariant for a sender and a second category containing information that can vary for a sender, and in which an alarm is triggered in the event that a variation is detected in the information contained in at least one of the information fields of the first category.

6. The method according to claim 1, in which a numerical string is constructed on the basis of at least some of the analysed information fields for an obtained management frame, and a signature is calculated by hashing said numerical string, and in which an alarm is triggered in the event that there is a variation between the signatures calculated for two successively obtained management frames.

7. The method as claimed in claim 1, furthermore comprising the determination of a statistic regarding the information contained in at least some of the information fields of the frame body of management frames received from a sender, and in which an alarm is triggered in the event of observing at least one management frame containing the address of said sender and a frame body having information fields that are inconsistent in relation to the statistic determined.

8. A device for detecting address spoofing in a wireless network, comprising:
obtention means for obtaining management frames transmitted over the wireless network, each management frame comprising an address of a sender of the frame and a frame body containing several information fields;
analysis means for analysing at least some of the information fields contained in several successively obtained management frames exhibiting one and the same sender address; and
triggering means for triggering an alarm in the event that a variation is detected in at least some of the analysed information fields.

9. The device according to claim 8, in which the analysis means comprise means for determining the number of information fields of the frame body of each management frame obtained, and in which the alarm triggering means are activated in the event that the number of information fields determined varies between two successively obtained management frames.

10. The device according to claim 8, in which the analysis means separate the information fields of the frame body into a first category containing information that is invariant for a sender and a second category containing information that can vary for a sender, and in which the alarm triggering means are activated in the event that a variation is detected in the information contained in at least one of the information fields of the first category.

11. A computer program to be installed in a device interfaced with at least one wireless network for execution by a processing unit of said device, the program comprising instructions for implementing a method as claimed in claim 1 during execution of the program by said processing unit.
